(19) United States
(12) Patent Application Publication
(10) Pub. No.: US 2026/0255008 A1
(43) Pub. Date: Aug. 27, 2026

(54) VIRTUAL REALITY VIDEO SYNCHRONIZATION REPRODUCTION DEVICE

(71) Applicants: RAKKI INC., Yamaguchi (JP); NTS, INC., Tokyo (JP)

(72) Inventors: Ryuji YOSHIDA, Yamaguchi (JP); Satoru FUKUDA, Tokyo (JP)

(21) Appl. No.: 18/995,480

(22) PCT Filed: Jan. 18, 2024
(86) PCT No.: PCT/JP2024/001251

§ 371 Date: Jan. 16, 2025

(30) Foreign Application Priority Data
Jan. 23, 2023 (JP) 2023-008178

(51) Int. Cl. H04N 21/43; H04N 21/81

(52) U.S. Cl. CPC H04N 21/43076; H04N 21/816

(57) ABSTRACT

A virtual reality (VR) video synchronization reproduction device allows viewers of a VR video to have conversations and be more satisfied while reducing overlapping of reproduced audio data in the VR video and the conversations. A VR video synchronization reproduction device (1) includes an administrator terminal (2), a receiver terminal (3A to 3C), and a server group (4) that communicates with the administrator terminal (2) and the receiver terminal (3A to 3C). The server group (4) includes a video distribution server (4A), an operation server (4B), a textual information transmission server (4C), and a voice information communication server (4D).

### FIELD OF THE INVENTION

The present invention relates to a virtual reality (VR) video synchronization reproduction device that reproduces a VR video in synchronization on multiple terminals, and particularly, to a VR video synchronization reproduction device that allows one of multiple terminals serving as an administrator terminal to control reproduction of a VR video on other terminals.

### BACKGROUND ART

Techniques for reproducing a single VR video on multiple terminals have been awaited. VR videos allow people to feel immersed in virtual spaces. Such techniques may allow customers to view a VR video at an event such as a seminar or a real estate viewing. The customers are thus expected to deeply understand the information provided in each event.

However, a VR video reproduced on multiple terminals may not be synchronized accurately on each terminal due to, for example, the data volume or the low line speed.

Techniques to overcome such an issue have been developed in recent years, including an invention directed to such a technique described in literature.

Patent Literature 1 describes a VR content viewing device that allows high-speed communication between terminals.

The device in Patent Literature 1 will be described below. The VR content viewing device described in Patent Literature 1 allows a first information terminal and a second information terminal to share VR content, or video data in a video format, in real time with a server device. The server device includes a depictor that depicts VR content based on a request from the first information terminal and the second information terminal, and a synchronizer that synchronizes the VR content between the first information terminal and the second information terminal based on synchronization information. The first information terminal and the second information terminal reproduce the VR content depicted by the depictor on their browsers, and transmit, while reproducing the VR content, line-of-sight information indicating a direction in which the viewer views the VR content as the synchronization information to the server device. The synchronizer instructs the depictor to depict the VR content based on the line-of-sight information in synchronization between the first information terminal and the second information terminal.

### CITATION LIST

### Patent Literature

Patent Literature 1: Japanese Unexamined Patent Application Publication No. 2019-71539

### SUMMARY OF INVENTION

### Technical Problem

However, the device described in Patent Literature 1 does not include a communicator for enabling voice communication between the first information terminal and the second information terminal. Thus, the operators of the first information terminal and the second information terminal may not have real-time conversations about, for example, the highlights of the VR video or their reactions to the VR video, and may not feel that they are viewing the video together but feel that they are viewing the video individually. Thus, the operators of the first information terminal and the second information terminal may be unsatisfied, without joy or a sense of unity that may be felt by viewing the video together. Although the operators can have real-time conversations, any audio data contained in the VR content and the conversations may overlap each other and be heard incompletely.

One or more aspects of the present invention are directed to a VR video synchronization reproduction device that reproduces a VR video while allowing the operators of multiple terminals used to view the VR video to have conversations and be more satisfied, and while reducing overlapping of reproduced audio data in the VR video and the conversations.

### Solution To Problem

In response to the above, a virtual reality video synchronization reproduction device according to a first aspect of the present invention includes an administrator terminal operable by an administrator, a receiver terminal operable by a receiver, and a server group that communicates with the administrator terminal and the receiver terminal. The server group includes a video distribution server, an operation server, a textual information transmission server, and a voice information communication server. The video distribution server distributes a virtual reality video including virtual reality-image information and virtual reality-audio information to the administrator terminal and the receiver terminal. The administrator terminal transmits, to the operation server, operation information in a text format to control reproduction and stop of the virtual reality video on the receiver terminal, and transmits, to the voice information communication server, administrator voice information in an audio format to be transmitted to the receiver terminal. The operation server transmits the operation information received from the administrator terminal to the textual information transmission server. The textual information transmission server transmits the received operation information to the receiver terminal. The voice information communication server transmits the received administrator voice information to the receiver terminal, receives receiver voice information in an audio format from the receiver terminal, and transmits the receiver voice information to the administrator terminal. The virtual reality video is reproduced in synchronization on the administrator terminal and the receiver terminal by the receiver terminal operating based on the operation information.

The structure according to the aspect of the invention uses a 360-degree or 180-degree virtual reality video as an example of a virtual reality video.

Although the number of administrator terminals and the number of receiver terminals are not limited, for example, one administrator terminal can simultaneously control one or more receiver terminals and may smoothly reproduce a virtual reality video or perform voice communication. However, multiple administrator terminals prioritized to control the receiver terminals can also smoothly reproduce, for example, a virtual reality video.

Although operation information from the administrator terminal is in a text format, administrator voice information from the administrator terminal and receiver voice information from the receiver terminal are in an audio format. Information transmitted from the administrator terminal is thus divided into the text and audio formats to reduce the communication load and to promptly transmit the operation information using the information in a text format that usually has a smaller data volume than information in an audio format. The voice information communication server may transmit the information in a text format from the receiver terminal to the administrator terminal.

In the structure according to the above aspect of the invention, after the video distribution server distributes a virtual reality video including virtual reality-image information and virtual reality-audio information to the administrator terminal and the receiver terminal, the administrator terminal transmits, to the receiver terminal through the operation server and the textual information transmission server, operation information for controlling reproduction or stop of reproduction of the distributed virtual reality video. The receiver terminal can thus reproduce or stop reproducing the virtual reality video distributed by the video distribution server.

More specifically, the virtual reality video reproduced by the receiver terminal is reproduced in synchronization on the administrator terminal and the receiver terminal by the receiver terminal operating based on the operation information.

The administrator terminal transmits administrator voice information to the receiver terminal through the voice information communication server. The receiver terminal generates receiver voice information in response to the received administrator voice information and transmits the receiver voice information to the administrator terminal through the voice information communication server. More specifically, the structure according to the aspect allows interactive voice communication between an administrator operating the administrator terminal and a receiver operating the receiver terminal. The receiver terminal may not respond to the received administrator voice information every time.

A virtual reality video synchronization reproduction device according to a second aspect of the present invention is the virtual reality video synchronization reproduction device according to the first aspect in which the administrator terminal includes an administrator terminal controller. When the administrator terminal controller transmits the administrator voice information to the receiver terminal through the voice information communication server, the administrator terminal controller transmits VR-audio stop alert information included in the operation information and indicating stop of reproduction of the virtual reality-audio information to the receiver terminal through the operation server and the textual information transmission server, and transmits a VR-audio stop instruction included in the operation information and instructing the receiver terminal to stop reproducing the virtual reality-audio information to the receiver terminal through the operation server and the textual information transmission server.

In addition to the effects produced by the first aspect, in the structure according to the above aspect of the invention, the administrator terminal controller preliminarily transmits the VR-audio stop alert information to the receiver terminal through, for example, the operation server when the administrator terminal controller transmits the administrator voice information to the receiver terminal through the voice information communication server, or more specifically, when the administrator intends to transmit their voice to the receiver. The receiver terminal then provides the VR-audio stop alert information converted to text or voice. The receiver can thus be preliminarily informed of stop of reproduction of the virtual reality-audio information alone.

When the administrator terminal transmits the VR-audio stop instruction to the receiver terminal through, for example, the operation server, the receiver terminal stops reproducing the virtual reality-audio information in response to the VR-audio stop instruction. Thus, the virtual reality-audio information is not interrupted by reproduction of the administrator voice information. The virtual reality-image information in the virtual reality video remains reproduced on the receiver terminal without being stopped.

A virtual reality video synchronization reproduction device according to a third aspect of the present invention is the virtual reality video synchronization reproduction device according to the second aspect in which only when the receiver terminal responds to the administrator voice information from the administrator terminal, the administrator terminal controller transmits, to the receiver terminal through the operation server and the textual information transmission server, receiver voice transmission alert information indicating that the receiver terminal is ready to transmit the receiver voice information.

In addition to the effects produced by the second aspect, in the structure according to the above aspect of the invention, the administrator terminal controller transmits the transmission alert information to the receiver terminal. The receiver is informed of being allowed to perform voice communication only when responding to the voice from the administrator.

A virtual reality video synchronization reproduction device according to a fourth aspect of the present invention is the virtual reality video synchronization reproduction device according to the first aspect or the second aspect in which the administrator terminal includes an administrator terminal display. The administrator terminal display displays the virtual reality video, an operation screen to receive input of the operation information, and an operation screen to receive input of the administrator voice information.

In addition to the effects produced by the first aspect or the second aspect, in the structure according to the above aspect of the invention, the administrator terminal display displays the virtual reality video and the operation screens simultaneously or at different times. For simultaneous display, for example, the operation screens may be superimposed on the virtual reality video while the virtual reality video is being reproduced.

A virtual reality video synchronization reproduction device according to a fifth aspect of the present invention is the virtual reality video synchronization reproduction device according to the fourth aspect in which the receiver terminal includes a receiver terminal controller, a receiver terminal display that displays the virtual reality video, and a motion sensor that detects a motion of the receiver terminal. The receiver terminal controller causes the receiver terminal display to display a motion video corresponding to detection data from the motion sensor based on the virtual reality video. The motion video is configurable with a viewpoint different from a viewpoint of the virtual reality video displayed on the administrator terminal display.

In the structure according to the above aspect of the invention, the motion video is detection data from the motion sensor read from video information, or more specifically, a piece of video information corresponding to the detected direction of the receiver terminal. Such reading is performed by, for example, a processor incorporated in a head-mounted display that can perform data communication with the receiver terminal, or by the receiver terminal controller that executes an application installed for reading the motion video.

In addition to the effects produced by the fourth aspect, in the structure according to the above aspect of the invention, the motion video is configurable with a viewpoint different from the viewpoint of the virtual reality video displayed on the administrator terminal display. Thus, each receiver can view the virtual reality video from the same viewpoint as the administrator or another receiver or a viewpoint different from the viewpoint of the administrator or another receiver.

### ADVANTAGEOUS EFFECTS

In the first aspect of the invention, the virtual reality video reproduced by the receiver terminal is reproduced in synchronization on the administrator terminal and the receiver terminal. Thus, the receiver can view the same virtual reality video simultaneously with at least the administrator. Thus, the receiver may have, for example, a sense of unity when viewing the video together with others and may be more satisfied.

For example, the receiver terminal cannot reproduce the virtual reality video independently of the administrator terminal. This reduces dissatisfaction of receivers resulting from, for example, one or more other receivers randomly stopping the virtual reality video and delaying the reproduction.

In addition, the administrator and the receiver can have interactive voice communication and thus have real-time conversations about, for example, the highlights of the virtual reality video or their reactions to the virtual reality video. The receivers can thus be satisfied further.

In the second aspect of the invention, in addition to the effects produced by the first aspect, reproduction of the virtual reality-audio information is stopped and thus reproduction of the administrator voice information is not interrupted by reproduction of the virtual reality-audio information. The receiver can thus clearly hear the speech of the administrator. In this state, the virtual reality-image information in the virtual reality video remains reproduced. Thus, the receiver can view the silent virtual reality video while listening to the speech of the administrator and while avoiding, for example, missing the highlights of the virtual reality video.

With the VR-audio stop alert information, the receiver can be preliminarily informed of stop of reproduction of the virtual reality-audio information alone, and thus is less likely to be surprised by the stop of the virtual reality-audio information.

In the third aspect of the invention, in addition to the effects produced by the second aspect, the receiver terminal cannot independently transmit receiver voice information to the administrator terminal. The speech of the receivers can thus be limited to the time after the speech of the administrator. The virtual reality video can thus be smoothly reproduced without, for example, loud voice or irrelevant conversations performed by receivers during reproduction of the virtual reality video being heard by the administrator or other receivers.

In the fourth aspect of the invention, in addition to the effects produced by the first aspect or the second aspect, when, for example, the operation screens can be superimposed on the virtual reality video while the virtual reality video is being reproduced, the operation information or the administrator voice information can be smoothly transmitted to the receiver terminal during reproduction of the virtual reality video. Thus, the receiver can further deeply understand the details of the virtual reality video without, for example, the administrator missing timing to explain the virtual reality video.

In the fifth aspect of the invention, in addition to the effects produced by the fourth aspect, the receiver can view the virtual reality video also from a viewpoint different from the viewpoint of the administrator or other receivers, and thus can freely view the virtual reality video in synchronization while facing in any direction.

### BRIEF DESCRIPTION OF THE DRAWINGS

FIG. 1 is a diagram of a virtual reality (VR) video synchronization reproduction device according to an embodiment.

FIG. 2(a) is an external view of an administrator terminal included in the VR video synchronization reproduction device according to the embodiment, and FIG. 2(b) is an external view of a receiver terminal included in the VR video synchronization reproduction device according to the embodiment.

FIG. 3 is a flowchart of a process performed by the VR video synchronization reproduction device according to the embodiment.

FIG. 4 is a flowchart of a process performed by the VR video synchronization reproduction device according to the embodiment.

### DETAILED DESCRIPTION

### Embodiment

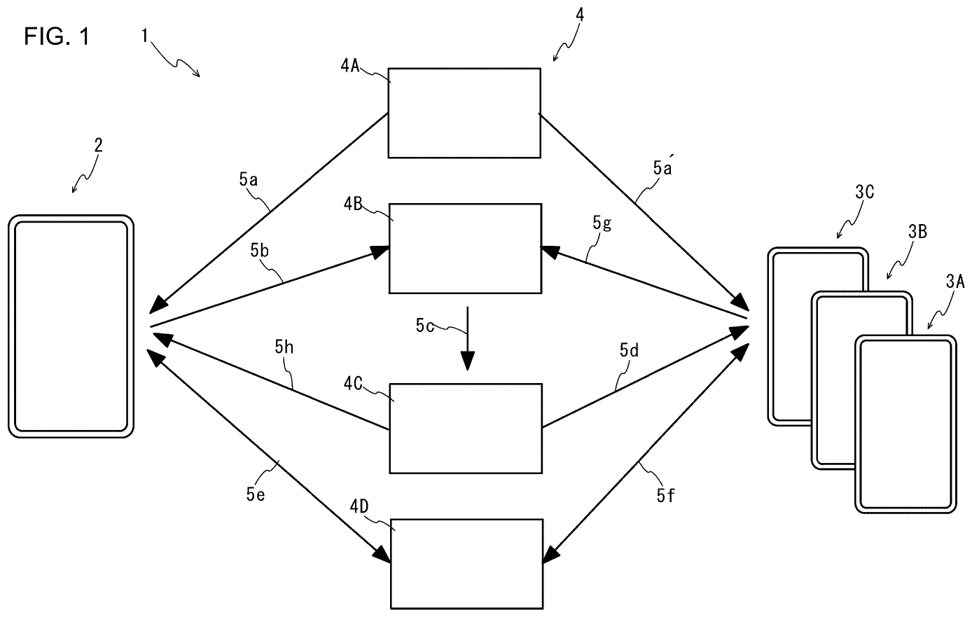

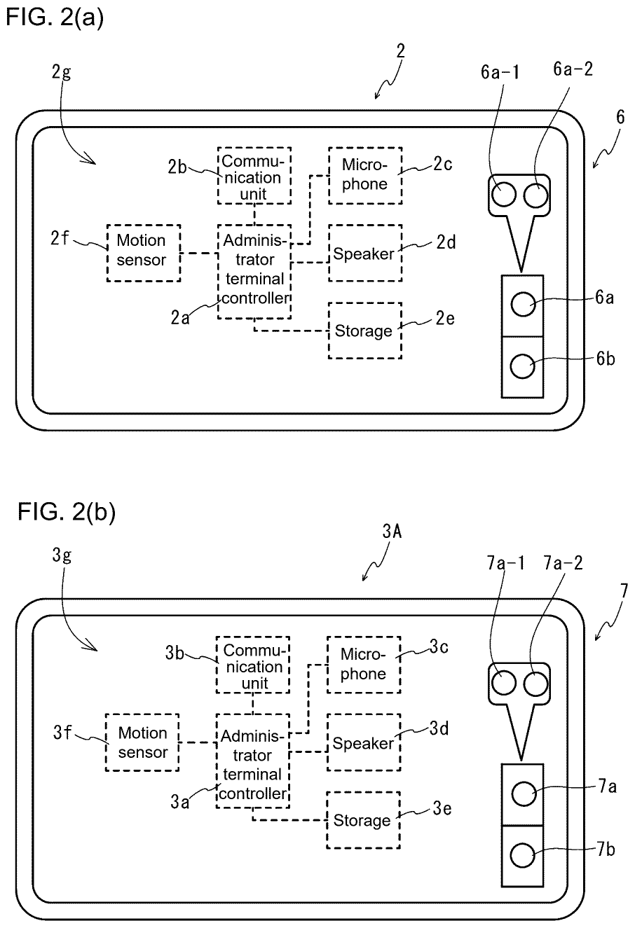

A virtual reality (VR) video synchronization reproduction device according to an embodiment of the present invention will be described in detail with reference to FIGS. 1 to 4. FIG. 1 is a diagram of the VR video synchronization reproduction device according to the embodiment. FIG. 2(a) is an external view of an administrator terminal included in the VR video synchronization reproduction device according to the embodiment. FIG. 2(b) is an external view of a receiver terminal included in the VR video synchronization reproduction device according to the embodiment.

As shown in FIG. 1, a VR video synchronization reproduction device 1 according to an embodiment includes one administrator terminal 2 operated by one administrator, three receiver terminals 3A to 3C operated by three receivers, and a server group 4 for communicating with the administrator terminal 2 and the receiver terminals 3A to 3C. The VR video synchronization reproduction device 1 may include fewer than three or four or more receiver terminals 3A to 3C as appropriate for the number of receivers. The administrator terminal 2 and the receiver terminals 3A to 3C may be smartphones, tablet terminals, or personal computers.

The server group 4 includes a video distribution server 4A, an operation server 4B, a textual information transmission server 4C, and a voice information communication server 4D. More specifically, the operation server 4B is an application programming interface (API) server, the textual information transmission server 4C is a WebSocket server, and the voice information communication server 4D is a Web Real-Time Communication (WebRTC) server.

The WebSocket server as the textual information transmission server 4C allows the administrator terminal 2 and the receiver terminals 3A to 3C to share operation information in real time.

The WebRTC server as the voice information communication server 4D allows real-time transmission and reception of audio data with a large volume, or allows the administrator terminal 2 and the receiver terminals 3A to 3C to transmit or receive audio.

The video distribution server 4A distributes a VR video including VR-image information and VR-audio information to the administrator terminal 2 and the receiver terminals 3A to 3C through communication paths 5a and 5a′. The VR video is, for example, a 360-degree VR video distributed with a Sky Sphere method being a method for bonding the 360-degree VR video formed by equirectangular projection to the inside of a sphere defined for the administrator terminal 2 or the receiver terminals 3A to 3C.

A program to form a VR video with the SkySphere method is accessed through a predetermined website, and downloaded and installed on the administrator terminal 2 and the receiver terminals 3A to 3C. In addition, a program to operate the administrator terminal 2 and the receiver terminals 3A to 3C in accordance with processes in a VR video synchronization reproduction method 100 (described later) is preliminarily installed on the administrator terminal 2 and the receiver terminals 3A to 3C.

As shown in FIG. 2(a), the administrator terminal 2 includes an administrator terminal controller 2a, a communication unit 2b that transmits, for example, operation information and administrator voice information and receives, for example, VR videos and receiver voice information, a microphone 2c that picks up voice produced by the administrator, a speaker 2d that outputs VR-audio information and receiver voice information for each of the receiver terminals 3A to 3C, a storage 2e that stores the operation information and the administrator voice information input through an administrator terminal display 2g and the microphone 2c, and an administrator terminal display 2g that includes a motion sensor 2f to detect the motion of the administrator terminal 2 and displays VR videos.

The operation information is information in a text format to control reproduction and stop of the VR video on the receiver terminals 3A to 3C. The administrator voice information is audio information to be transmitted to the receiver terminals 3A to 3C, or more specifically, voice picked up by the microphone 2c and converted to electronic data.

Among the above components of the administrator terminal 2, the administrator terminal display 2g displays, in addition to the VR video, an operation screen 6 operable to receive input of the operation information and the administrator voice information. The operation screen 6 constantly displays an operation information input button 6a and an administrator voice input button 6b. In some embodiments, the operation screen 6 may be displayed when requested by the administrator pressing and holding the administrator terminal display 2g.

The administrator operates the operation information input button 6a and inputs operation information to simultaneously reproduce or stop the VR-image information and the VR-audio information. The administrator operates the administrator voice input button 6b and inputs the administrator voice information through the microphone 2c.

In contrast, the administrator operates a VR-image information operation button 6a-1 and inputs the operation information to reproduce or stop the VR-image information alone, and operates a VR-audio information operation button 6a-2 and inputs the operation information to reproduce or stop the VR-audio information alone. The VR-image information operation button 6a-1 and the VR-audio information operation button 6a-2 are displayed when the administrator presses and holds the operation information input button 6a. In some embodiments, the VR-image information operation button 6a-1 and the VR-audio information operation button 6a-2 may be displayed constantly.

The motion sensor 2f is, for example, an acceleration sensor that detects acceleration in three orthogonal directions, and detects the viewpoint direction of the administrator wearing a head-mounted display (not shown) on which the administrator terminal 2 is set.

The administrator terminal controller 2a displays the motion video corresponding to the detection data of the motion sensor 2f based on the VR video on the administrator terminal display 2g. More specifically, the administrator terminal controller 2a selects, from the VR videos, a motion video corresponding to the detection data of the motion sensor 2f with a known method using an application installed in the storage 2e.

All the operations of, for example, the communication unit 2b are controlled by the administrator terminal controller 2a. All the pieces of information input into and output from the administrator terminal 2 are stored into the storage 2e.

Referring back to FIG. 1, the administrator terminal 2 transmits the operation information to the operation server 4B through a communication path 5b, and transmits the administrator voice information to the voice information communication server 4D through a communication path 5e.

The operation server 4B further transmits the operation information received from the administrator terminal 2 to the textual information transmission server 4C through a communication path 5c. The communication protocol for the communication paths 5b and 5c is Hypertext Transfer Protocol (HTTP). The communication protocol for the communication path 5e is WebRTC.

The textual information transmission server 4C collectively transmits the received operation information to the receiver terminals 3A to 3C through a communication path 5d. The communication protocol for the communication path 5d is WebSocket.

The voice information communication server 4D collectively transmits the received administrator voice information to the receiver terminals 3A to 3C through a communication path 5f, receives the receiver voice information from the receiver terminals 3A to 3C through the communication path 5f, and transmits the receiver voice information to the administrator terminal 2 through the communication path 5e. More specifically, the receiver voice information is voice emitted by the receiver toward the administrator through a microphone 3c (refer to FIG. 2(b)). The communication protocol for the communication path 5f is WebRTC.

As shown in FIG. 2(b), the receiver terminal 3A of the receiver terminals 3A to 3C includes a receiver terminal controller 3a, a communication unit 3b that receives, for example, VR videos and operation information transmitted from the administrator terminal 2 and receives and transmits receiver voice information from and to the receiver terminals 3A to 3C, a microphone 3c that picks up voice emitted by the receiver, a speaker 3d that outputs the VR-audio information, the administrator voice information, and the receiver voice information for each of the receiver terminals 3A to 3C, a storage 3e that stores, for example, the receiver voice information input through the microphone 3c, and a receiver terminal display 3g that includes a motion sensor 3f to detect the motion of the receiver terminal 3A and displays VR videos.

The receiver voice information is information in an audio format to be transmitted to the administrator terminal 2, or more specifically, voice picked up by the microphone 3c and converted to electronic data.

Among the above components of the receiver terminal 3A, the receiver terminal display 3g constantly displays a state display screen 7 in addition to the VR video. The state display screen 7 constantly displays a VR video reproduction state button 7a indicating the reproduction state of the VR video and a voice state button 7b indicating the input state of the receiver voice information. In some embodiments, the state display screen 7 may be displayed when requested by the receiver pressing and holding the receiver terminal display 3g.

The VR video reproduction state button 7a is lit when the administrator simultaneously reproduces the VR-image information and the VR-audio information, and is unlit when the administrator simultaneously stops reproducing the VR-image information and the VR-audio information. The voice state button 7b blinks when the receiver is allowed to input the receiver voice information through the microphone 3c to inform the receiver of the timing.

In contrast, a video reproduction button 7a-1 is lit when the administrator reproduces the VR-image information alone, and a voice reproduction button 7a-2 is lit when the administrator reproduces the VR-audio information alone.

The state display screen 7 has no button operable by the receiver to control reproduction or stop of the VR video or to input the receiver voice information at intended timing.

The motion sensor 3f has the same components and functions as the motion sensor 2f included in the administrator terminal 2. Thus, the receiver terminal controller 3a causes the receiver terminal display 3g to display the motion video corresponding to detection data of the motion sensor 3f based on the VR video.

The motion video displayed on the receiver terminal 3A may be formed from a viewpoint different from the viewpoint for the motion video or the VR video displayed on the administrator terminal display 2g.

All the operations of, for example, the communication unit 3b are controlled by the receiver terminal controller 3a. All the pieces of information input into and output from the receiver terminal 3A are stored into the storage 3e.

The structure and the functions of the receiver terminals 3B and 3C are the same as the structure and the functions of the receiver terminal 3A.

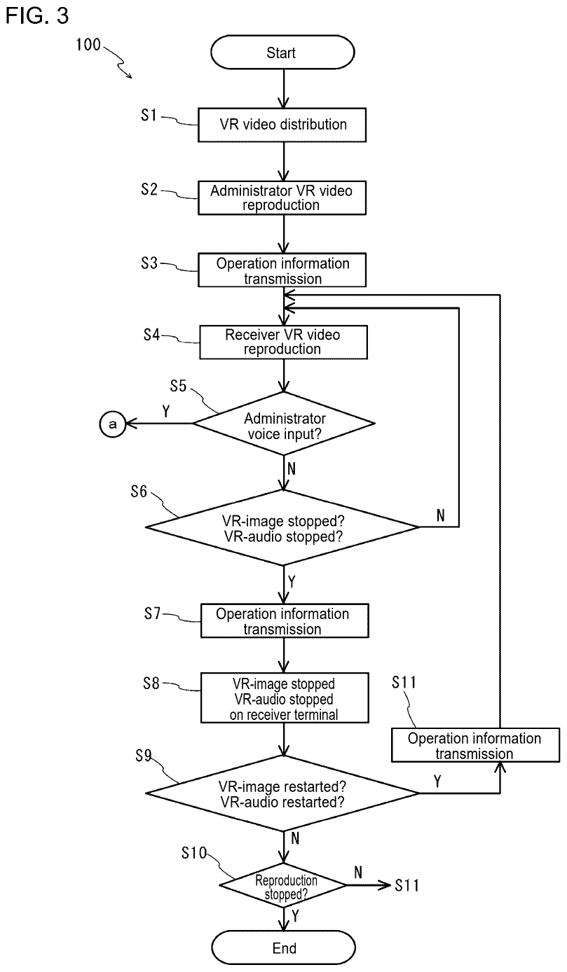

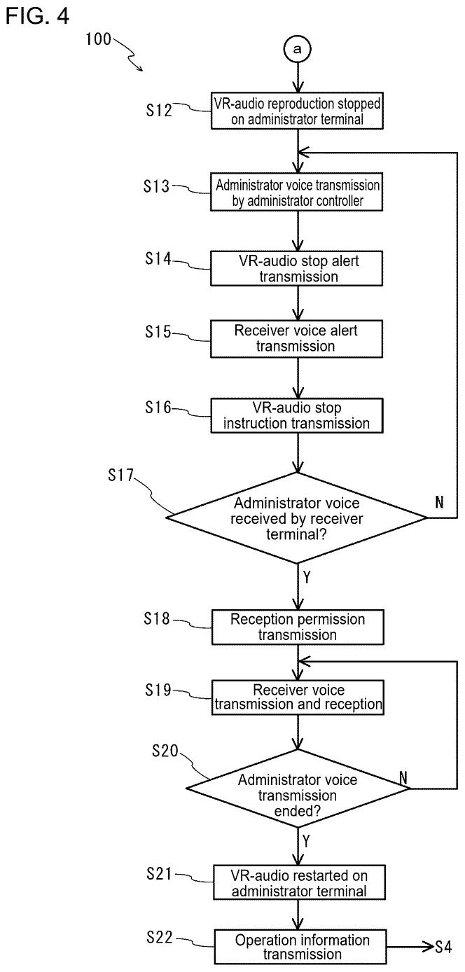

With reference to FIGS. 3 and 4, the operation of the VR video synchronization reproduction device according to the embodiment will now be described. FIGS. 3 and 4 are flowcharts of processes performed by the VR video synchronization reproduction device according to the embodiment.

As shown in FIG. 3, the VR video synchronization reproduction device 1 implements a VR video synchronization reproduction method 100 including VR video distribution in step S1 to operation information transmission in step S22. These processes will be described below sequentially from VR video distribution in step S1.

The VR video distribution in step S1 is performed by the video distribution server 4A to distribute VR videos to the administrator terminal 2 and the receiver terminals 3A to 3C through the communication paths 5a and 5a′. Before the start of this process, as described above, an application for reproducing VR videos is installed on the administrator terminal 2 and the receiver terminals 3A to 3C. Thus, the administrator terminal controller 2a and the receiver terminal controller 3a in each of the receiver terminals 3A to 3C can reproduce the distributed VR videos.

Examples of VR videos include, but not limited to, travel experience, scenery viewing, sports experience, and flight experience.

Administrator VR video reproduction in step S2 is performed by the administrator terminal controller 2a in the administrator terminal 2 to simultaneously reproduce the VR-image information and the VR-audio information in the distributed VR video on the administrator terminal display 2g and the speaker 2d based on the operation information input through the operation information input button 6a on the operation screen 6.

Operation information transmission in step S3 includes first, second, and third transmission processes performed by the administrator terminal controller 2a. The first transmission process is performed to transmit the operation information input through the operation information input button 6a to the operation server 4B through the communication path 5b. The second transmission process is performed to transmit the operation information transmitted to the operation server 4B to the textual information transmission server 4C through the communication path 5c. The third transmission process is performed to transmit the operation information transmitted to the textual information transmission server 4C to the communication unit 3b in the receiver terminal 3A through the communication path 5d. With the first to third transmission processes, the operation information is transmitted from the administrator terminal 2 to the receiver terminals 3A to 3C.

Receiver VR video reproduction in step S4 is performed by the receiver terminal controller 3a to reproduce the VR-image information and the VR-audio information in the VR video received in advance on the receiver terminal display 3g and the speaker 3d based on the operation information received through the communication unit 3b.

In response to receiving the operation information, as described above, the receiver terminal controller 3a in each of the receiver terminals 3A to 3C including the motion sensor 3f forms and reproduces a motion video based on the VR video.

Administrator voice input determination in step S5 is performed when the administrator inputs the administrator voice information, or more specifically, is performed by the administrator terminal controller 2a, after the administrator operates the administrator voice input button 6b, to determine whether the administrator voice information is input through the microphone 2c and determine a process to be performed thereafter.

When the administrator voice information is not input within a predetermined period, the administrator terminal controller 2a continues reproducing the VR video. When the administrator voice information is input within the predetermined period, the processing subsequent to process a in FIGS. 3 and 4 is performed.

VR video stop determination in step S6 is performed by the administrator to stop reproducing the VR video, or more specifically, is performed by the administrator terminal controller 2a to determine whether the operation information to stop reproducing the VR video is input through the operation information input button 6a, whether the operation information to stop reproducing the VR-image information alone is input through the VR-image information operation button 6a-1, or whether the operation information to stop reproducing the VR-audio information alone is input through the VR-audio information operation button 6a-2.

When the operation information is not input within a predetermined period, the administrator terminal controller 2a returns to the receiver VR video reproduction in step S4 to continue reproducing the VR video, the VR-image information, or the VR-audio information. When the operation information is input within the predetermined period, the administrator terminal controller 2a performs operation information transmission in step S7.

The operation information transmission in step S7 is performed by the administrator terminal controller 2a to transmit the operation information to stop reproducing the VR video, the VR-image information, or the VR-audio information to the receiver terminals 3A to 3C through the communication paths 5b, 5c, and 5d.

Receiver reproduction stop in step S8 is performed by the receiver terminal controller 3a when the communication unit 3b of each of the receiver terminals 3A to 3C receives the operation information to stop reproducing the VR video, the VR-image information, or the VR-audio information on the receiver terminal display 3g, the speaker 3d, or both based on the operation information.

Receiver reproduction restart in step S9 is performed by the administrator terminal controller 2a to input the operation information to restart reproducing the VR video, the VR-image information, or the VR-audio information that is being stopped through an operation on, for example, the operation information input button 6a.

When the operation information is not input within a predetermined period, the administrator terminal controller 2a performs an inquiry in step S10. When the operation information is input within the predetermined period, the administrator terminal controller 2a returns to the receiver VR video reproduction in step S4, and restarts reproducing the VR video, the VR-image information, or the VR-audio information. Also, the administrator terminal controller 2a performs operation information transmission in step S11.

The inquiry in step S10 is performed by the administrator terminal controller 2a to inquire of the administrator whether to restart reproducing the VR video, the VR-image information, or the VR-audio information that is being stopped. More specifically, the administrator terminal controller 2a displays the text such as “Do you want to stop reproduction?” on the operation screen 6.

When the administrator presses and holds, for example, the operation information input button 6a on the operation screen 6 in response to this text, the administrator terminal controller 2a ends reproducing, for example, the VR video that is being stopped without restarting the reproduction. Thus, the VR video synchronization reproduction method 100 ends.

In contrast, when the administrator double taps, for example, the operation information input button 6a on the operation screen 6 in response to this text, the administrator terminal controller 2a performs the operation information transmission in step S11.

The operation information transmission in step S11 is performed by the administrator terminal controller 2a to transmit the operation information to restart reproducing the VR video, the VR-image information, or the VR-audio information that is being stopped to the receiver terminals 3A to 3C through the operation server 4B, the textual information transmission server 4C, and the communication paths 5b, 5c, and 5d. Thus, the receiver terminal controller 3a in each of the receiver terminals 3A to 3C restarts reproducing, for example, the VR video based on the operation information.

The processing subsequent to process a performed when the administrator voice information is input within a predetermined period after the administrator voice input determination in step S5 will be described with reference to FIG. 4.

Administrator voice processing in step S12 is performed by the administrator terminal controller 2a in the administrator terminal 2 to stop reproducing the VR-audio information alone in the VR video that is being reproduced. More specifically, when the VR-audio information operation button 6a-2 is pressed and held, the administrator terminal controller 2a detects input of the operation information to stop reproducing the VR-audio information alone.

Administrator voice transmission in step S13 is performed by the administrator terminal controller 2a to transmit the administrator voice information to the voice information communication server 4D and the receiver terminals 3A to 3C through the communication paths 5e and 5f.

VR audio stop alert transmission in step S14 is performed by the administrator terminal controller 2a when transmitting the administrator voice information to the receiver terminals 3A to 3C in the administrator voice transmission in step S13 to transmit VR-audio stop alert information included in the operation information and indicating stop of reproduction of the VR-audio information alone to the receiver terminals 3A to 3C through the operation server 4B, the textual information transmission server 4C, and the communication paths 5b, 5c, and 5d.

After receiving the VR-audio stop alert information, the receiver terminal controller 3a in each of the receiver terminals 3A to 3C provides, to the receiver, the information using the text on the operation screen 6 or the voice through the speaker 3d.

Receiver voice alert transmission in step S15 is performed by the administrator terminal controller 2a to transmit, only when the receiver terminals 3A to 3C respond to the administrator voice information from the administrator terminal 2, receiver voice transmission alert information indicating that the receiver terminals 3A to 3C are ready to transmit the receiver voice information to the receiver terminals 3A to 3C through the operation server 4B, the textual information transmission server 4C, and the communication paths 5b, 5c, and 5d. This process may be performed before or at the same time as the VR audio stop alert transmission in step S14.

After receiving the receiver voice transmission alert information, the receiver terminal controller 3a in each of the receiver terminals 3A to 3C provides, to the receiver, the information using the text on the operation screen 6 or the voice through the speaker 3d.

VR-audio stop instruction transmission in step S16 is performed by the administrator terminal controller 2a to transmit a VR-audio stop instruction included in the operation information and instructing the receiver terminals 3A to 3C to stop reproducing the VR-audio information to the receiver terminals 3A to 3C through, for example, the operation server 4B. Thus, the receiver terminal controller 3a in each of the receiver terminals 3A to 3C stops reproducing the VR-audio information in response to the VR-audio stop instruction.

Reception permission transmission determination in step S17 is performed by the administrator terminal controller 2a to determine whether a reception permission notice is to be transmitted to the voice information communication server 4D. The reception permission notice indicates that the voice information communication server 4D is allowed to receive receiver voice information from the receiver terminals 3A to 3C only when the receiver terminals 3A to 3C receive the administrator voice information from the administrator terminal 2.

In the program preliminarily installed on the receiver terminals 3A to 3C to implement the VR video synchronization reproduction method 100, when each of the receiver terminals 3A to 3C receives the administrator voice information from the administrator terminal 2, the receiver terminal controller 3a in each of the receiver terminals 3A to 3C immediately transmits reception completion information in a text format to the administrator terminal 2 through a communication path 5g, the operation server 4B, the communication path 5c, the textual information transmission server 4C, and a communication path 5h. The communication protocol for the communication path 5g is HTTP. The communication protocol for the communication path 5h is WebSocket.

In this process, the administrator terminal controller 2a determines whether the administrator terminal 2 has received reception completion information from the receiver terminals 3A to 3C. When the administrator terminal controller 2a determines that the administrator terminal 2 has received the reception completion information, reception permission transmission in step S18 is performed. When the administrator terminal controller 2a determines that the administrator terminal 2 has not received the reception completion information, the processing returns to the administrator voice transmission in step S13.

The reception permission transmission in step S18 is performed by the administrator terminal controller 2a to transmit the reception permission notice to allow the voice information communication server 4D to receive the receiver voice information only when the receiver terminals 3A to 3C receive the administrator voice information from the administrator terminal 2.

When receiving the reception permission notice transmitted by the administrator terminal controller 2a, the voice information communication server 4D receives the receiver voice information from each of the receiver terminals 3A to 3C through the communication path 5f, and transmits the information to the administrator terminal 2 through the communication path 5e.

Receiver voice transmission and reception in step S19 allows the administrator and each receiver to have actual, interactive voice communication, and includes receiver voice reception and administrator voice transmission performed by the administrator terminal controller 2a. The receiver voice reception is performed to cause the voice information communication server 4D to transmit the receiver voice information received from the receiver terminals 3A to 3C to the administrator terminal 2 and to cause the speaker 2d to output the information as voice hearable by the administrator. The administrator voice transmission is performed to cause the microphone 2c to pick up sound responding to the voice heard by the administrator and to transmit the sound to the receiver terminals 3A to 3C as new administrator voice information.

When an administrator voice transmission end notice indicating the end of transmission of administrator voice is not input into the administrator terminal 2 during the receiver voice transmission and reception in step S19, the administrator terminal controller 2a continues transmitting and receiving voice of the administrator and the receiver. The administrator voice transmission end notice may be, for example, information in a text format input by the administrator pressing and holding the administrator voice input button 6b.

Administrator voice transmission end determination in step S20 is performed by the administrator terminal controller 2a to determine processing to be performed thereafter based on whether the administrator voice transmission end notice is input. When the administrator voice transmission end notice is input, the administrator terminal controller 2a performs VR audio restart in step S21. When the administrator voice transmission end notice is not input, the administrator terminal controller 2a continues performing the receiver voice transmission and reception in step S19.

The VR audio restart in step S21 is performed by the administrator terminal controller 2a to cause the administrator terminal 2 to restart reproducing the VR-audio information. Thus, the VR-audio information is reproduced in addition to the VR-image information that is being reproduced.

The operation information transmission in step S22 is performed by the administrator terminal controller 2a to cause the receiver terminals 3A to 3C to restart reproducing the VR-audio information. Thus, the receiver terminals 3A to 3C simultaneously reproduce the VR-image information and the VR-audio information to be in the same state as in the receiver VR video reproduction in step S4.

The VR video synchronization reproduction device 1 can perform the VR video distribution in step S1 to the operation information transmission in step S22 as described above.

In the operation information transmission in step S3, the receiver terminals 3A to 3C reproduce the VR video, the VR-image information, or the VR-audio information based on the operation information. Thus, the administrator terminal 2 and the receiver terminals 3A to 3C reproduce the VR video, the VR-image information, or the VR-audio information in synchronization.

In the operation information transmission in steps S7 and S11, the receiver terminals 3A to 3C stop or restart the VR video, the VR-image information, or the VR-audio information based on the operation information. Thus, the receiver terminals 3A to 3C cannot reproduce or stop reproducing, for example, the VR video independently of the administrator terminal.

In the receiver VR video reproduction in step S4, each of the receiver terminals 3A to 3C forms and reproduces a motion video based on the VR video. Thus, when the VR video is, for example, a scenic video, the receivers can simultaneously view different landscapes, for example, the receiver of the receiver terminal 3A views the mountain, the receiver of the receiver terminal 3B views the sea, and the receiver of the receiver terminal 3C views the woods.

When the administrator transmits the administrator voice information in the administrator voice transmission in step S13, the receiver terminal controller 3a automatically stops reproducing the VR-audio information for the corresponding one of the receiver terminals 3A to 3C in the VR-audio stop instruction transmission in step S16. Thus, the administrator voice is not interrupted by the VR-audio information. Thus, the receiver of each of the receiver terminals 3A to 3C can clearly hear the speech of the administrator.

Before stopping reproducing the VR-audio information on the corresponding one of the receiver terminals 3A to 3C, the receiver terminal controller 3a informs the receiver of the VR-audio stop alert information in the VR audio stop alert transmission in step S14. Thus, the receiver is less likely to be surprised by the stop of the VR-audio information or to be concerned about any trouble.

The VR video synchronization reproduction device 1 allows the administrator terminal 2 and the receiver terminals 3A to 3C to have real-time conversations while the VR-audio information is stopped in the receiver voice transmission and reception in step S19. The administrator and the receivers can thus enjoy conversations with smooth voice exchange without feeling stress, and may have an increased sense of unity and thus be more satisfied.

Before the administrator terminal 2 and the receiver terminals 3A to 3C have conversations, the receiver voice transmission alert information is transmitted to the receiver terminals 3A to 3C in the receiver voice alert transmission in step S15. In addition, through the reception permission transmission in step S18 and the receiver voice transmission and reception in step S19, the administrator and each receiver are allowed to have actual, interactive voice communication only when the administrator terminal controller 2a transmits the reception permission notice. This technique can reliably reduce the receiver having conversations without permission of the administrator. This technique thus allows smooth reproduction of the VR-image information while allowing a large number of receivers to simultaneously have conversations.

The VR video synchronization reproduction device 1 according to an embodiment of the present invention is not limited to the structure described in the above embodiment. For example, the VR video synchronization reproduction device 1 may implement the VR video synchronization reproduction method 100 without the administrator voice input determination in step S5 and the administrator voice processing in step S12 to the operation information transmission in step S22.

In some embodiments, the VR video synchronization reproduction device 1 may implement the VR video synchronization reproduction method 100 without the reception permission transmission determination in step S17 and the reception permission transmission in step S18.

### INDUSTRIAL APPLICABILITY

The VR video synchronization reproduction device according to an embodiment of the present invention may be used to reproduce a VR video in synchronization on multiple terminals.

### REFERENCE SIGNS LIST

1 VR video synchronization reproduction device
2 administrator terminal
2a administrator terminal controller
2b communication unit
2c microphone
2d speaker
2e storage
2f motion sensor
2g administrator terminal display
3A, 3B, 3C receiver terminal
3a receiver terminal controller
3b communication unit
3c microphone
3d speaker
3e storage
3f motion sensor
3g receiver terminal display
4 server group
4A video distribution server
4B operation server
4C textual information transmission server
4D voice information communication server
5a, 5a', 5b, 5c, 5d, 5e, 5f, 5g, 5h communication path
6 operation screen
6a operation information input button
6a-1 VR-image information operation button
6a-2 VR-audio information operation button
6b administrator voice input button
7 state display screen
7a VR video reproduction state button
7a-1 video reproduction button
7a-2 voice reproduction button
7b voice state button
100 VR video synchronization reproduction method

1. A virtual reality video synchronization reproduction device (1), comprising:
an administrator terminal (2) operable by an administrator;
a receiver terminal (3A, 3B, 3C) operable by a receiver; and
a server group (4) configured to communicate with the administrator terminal (2) and the receiver terminal (3A, 3B, 3C), the server group (4) including a video distribution server (4A), an operation server (4B), a textual information transmission server (4C), and a voice information communication server (4D),
wherein the video distribution server (4A) distributes a virtual reality video including virtual reality-image information and virtual reality-audio information to the administrator terminal (2) and the receiver terminal (3A, 3B, 3C),
the administrator terminal (2) transmits, to the operation server (4B), operation information in a text format to control reproduction and stop of the virtual reality video on the receiver terminal (3A, 3B, 3C), and transmits, to the voice information communication server (4D), administrator voice information in an audio format to be transmitted to the receiver terminal (3A, 3B, 3C),
the operation server (4B) transmits the operation information received from the administrator terminal (2) to the textual information transmission server (4C),
the textual information transmission server (4C) transmits the received operation information to the receiver terminal (3A, 3B, 3C),
the voice information communication server (4D) transmits the received administrator voice information to the receiver terminal (3A, 3B, 3C), receives receiver voice information in an audio format from the receiver terminal (3A, 3B, 3C), and transmits the receiver voice information to the administrator terminal (2), and
the virtual reality video is reproduced in synchronization on the administrator terminal (2) and the receiver terminal (3A, 3B, 3C) by the receiver terminal (3A, 3B, 3C) operating based on the operation information.

2. The virtual reality video synchronization reproduction device (1) according to claim 1, wherein
the administrator terminal (2) includes an administrator terminal controller (2a), and
when the administrator terminal controller (2a) transmits the administrator voice information to the receiver terminal (3A, 3B, 3C) through the voice information communication server (4D), the administrator terminal controller (2a) transmits VR-audio stop alert information included in the operation information and indicating stop of reproduction of the virtual reality-audio information to the receiver terminal (3A, 3B, 3C) through the operation server (4B) and the textual information transmission server (4C), and transmits a VR-audio stop instruction included in the operation information and instructing the receiver terminal (3A, 3B, 3C) to stop reproducing the virtual reality-audio information to the receiver terminal (3A, 3B, 3C) through the operation server (4B) and the textual information transmission server (4C).

3. The virtual reality video synchronization reproduction device (1) according to claim 2, wherein
only when the receiver terminal (3A, 3B, 3C) responds to the administrator voice information from the administrator terminal (2), the administrator terminal controller (2a) transmits, to the receiver terminal (3A, 3B, 3C) through the operation server (4B) and the textual information transmission server (4C), receiver voice transmission alert information indicating that the receiver terminal (3A, 3B, 3C) is ready to transmit the receiver voice information.

4. The virtual reality video synchronization reproduction device (1) according to claim 1, wherein
the administrator terminal (2) includes an administrator terminal display (2g), and
the administrator terminal display (2g) displays the virtual reality video, an operation screen (6) to receive input of the operation information, and an operation screen (6) to receive input of the administrator voice information.

5. The virtual reality video synchronization reproduction device (1) according to claim 4, wherein
the receiver terminal (3A, 3B, 3C) includes
a receiver terminal controller (3a),
a receiver terminal display (3g) configured to display the virtual reality video, and
a motion sensor (3f) configured to detect a motion of the receiver terminal (3A, 3B, 3C),
the receiver terminal controller (3a) causes the receiver terminal display (3g) to display a motion video corresponding to detection data from the motion sensor (3f) based on the virtual reality video, and
the motion video is configurable with a viewpoint different from a viewpoint of the virtual reality video displayed on the administrator terminal display (2g).

6. The virtual reality video synchronization reproduction device (1) according to claim 2, wherein
the administrator terminal (2) includes an administrator terminal display (2g), and
the administrator terminal display (2g) displays the virtual reality video, an operation screen (6) to receive input of the operation information, and an operation screen (6) to receive input of the administrator voice information.

7. The virtual reality video synchronization reproduction device (1) according to claim 6, wherein
the receiver terminal (3A, 3B, 3C) includes
a receiver terminal controller (3a),
a receiver terminal display (3g) configured to display the virtual reality video, and
a motion sensor (3f) configured to detect a motion of the receiver terminal (3A, 3B, 3C),
the receiver terminal controller (3a) causes the receiver terminal display (3g) to display a motion video corresponding to detection data from the motion sensor (3f) based on the virtual reality video, and
the motion video is configurable with a viewpoint different from a viewpoint of the virtual reality video displayed on the administrator terminal display (2g).
